(19) United States
(12) Patent Application Publication
(10) Pub. No.: US 2015/0371227 A1
(43) Pub. Date: Dec. 24, 2015

(54) Registering a Mobile User

(71) Applicant: BARCLAYS BANK PLC, London (GB)

(72) Inventors: Darren Foulds, Hampshire (GB); Philip John Sowter, Essex (GB); Simon Bartlett, Wigan (GB); Jeremy Goldstone, Manchester (GB); Dermot John Dwyer, High Peak (GB); Ian Sayers, Cheshire (GB); Conall O'Brien, Cheshire (GB); Jim Winters, Shropshire (GB)

(73) Assignee: Barclays Bank PLC, London (GB)

(21) Appl. No.: 14/763,960

(22) PCT Filed: Jan. 30, 2013
(86) PCT No.: PCT/EP2013/051802

§ 371 Date: Jul. 28, 2015

(51) Int. Cl. G06Q 20/40; G06Q 20/22; G06Q 20/32; H04W 12/06; G06Q 20/38

(52) U.S. Cl. CPC G06Q 20/40; H04W 12/06; G06Q 20/3821; G06Q 20/32; G06Q 20/223

(57) ABSTRACT

Method and system of registering a user of a mobile device comprising: obtaining data identifying a user. Obtaining account data. Retrieving data uniquely identifying a mobile device. Authenticating the user with the mobile device. Validating the user with the account using the data identifying the user and the account data.

### FIELD OF THE INVENTION

The present invention relates to a system and method for registering a user and in particular for registering a user with a mobile financial services application.

### BACKGROUND OF THE INVENTION

Improving the usability and convenience of financial services is important to customers and institutions. This may be achieved to some extent by providing such services on a mobile platform such as a mobile telephone. Whilst this facilitates ease of use and improved convenience to users, this can increase security risks. Furthermore, as such mobile applications provide access to users' financial accounts then potential liability for security failures can be large.

Certain applications require the use of additional hardware such as bankcard readers and dynamic pass code generators (RSA keyfobs, etc). Whilst these devices may improve security, they also reduce the convenience to a user who has to remember and carry additional items.

Registering a user to a service can involve additional security risks and so particular care should be taken at this stage. However, such additional measures can further reduce user convenience. Therefore, there is a need to improve security when registering a user with a financial service accessible through a mobile device, whilst maintaining user convenience.

### SUMMARY OF THE INVENTION

Against this background and in accordance with a first aspect there is provided a method of registering a user of a mobile device comprising the steps of:

obtaining data identifying a user;

obtaining account data;

retrieving data uniquely identifying a mobile device;

authenticating the user with the mobile device; and

validating the user with the account using the data identifying the user and the account data. Therefore, security may be improved by binding the user with the account, the user with the mobile device and therefore, the mobile device with the account. This registration process may be used for many different types of account including financial accounts, bank accounts, credit card accounts, peer-to-peer payment accounts, mobile wallets and loyalty schemes, etc.

Preferably, the account may be a financial account such as a bank or credit card account. One or more accounts may be registered to the user.

Preferably, validating the user may occur outside of the mobile device.

Optionally, the data uniquely identifying the mobile device may be any one or more selected from the group consisting of: MAC address, WiFi identifier, international mobile subscriber identity, IMSI, unique identifier ID, UDID, near field communication, NFC, identifier, MSISDN, and IMEI. Other stored codes or numbers may be used.

Preferably, authenticating the user with the mobile device comprises a password, pass phrase, pass code or pass number challenge.

Optionally, validating the user may comprise the steps of:

sending a payment with a reference to the account; and

receiving from the user the reference. Such statement information may only be legitimately available to the user and so confirms that the account belongs to the user.

Optionally, validating the user may comprise the steps of:

retrieving user data associated with the account from a third party; and

comparing the retrieved user data with the obtained data identifying the user. This procedure may be used where the account is not an account located within the control of the registering system. For example, this may be a bank account with another (third party) bank.

Preferably, the method may further comprise the step of setting an access password, pass phrase, pass code or pass number before obtaining the data identifying the user and obtaining the account data. Setting up the pass code may be carried out before any part of the registration procedure commences. Should the registration process be suspended or restarted then a pass code challenge may be issued before resumption.

Optionally, the method may further comprise the step of requiring input from the user of a correct access password, pass phrase, pass code or pass number before the user is registered.

Optionally, the data identifying the user may be any one or more selected from the group consisting of: name, date of birth, gender, nationality, place of birth and nationality of parent.

Optionally, obtaining data identifying a user may occur before authenticating the user with the mobile device, which occurs before validating the user the account.

Preferably, the user may be registered with a peer-to-peer payments system. The method and system may be used to register users with other types of services.

In accordance with a second aspect, there is provided a system for registering a user of a mobile device comprising:

a database of registered users; and

logic configured to:
receive data identifying a user,
receive account data,
authenticate the user with the mobile device using data uniquely identifying the mobile device retrieved from the mobile device,
validate the user with the account using the data identifying the user and the account data, and
if the validation is successful, adding the user to the database of registered users. The system may also comprise one or more mobile devices. The logic may be executed within one or more processors or servers or be distributed across a network, for example.

Optionally, the system may further comprise a network connection configured to receive data from one or more mobile devices. The network connection may be to the Internet or to a mobile network, for example.

Preferably, the system may further comprise an electronic peer-to-peer payment system configured to initiate payments between registered users.

In accordance with a third aspect, there is provided a mobile application for registering a user of a mobile device comprising logic configured to:

obtain data identifying a user;

obtain account data;

retrieve data uniquely identifying a mobile device;

authenticate the user with the mobile device; and

receive confirmation that the user and the account have been verified using the data identifying the user and the account data. The mobile application may be installed or downloaded onto the mobile device, such as a smart phone running a suitable operating system (e.g. iOS or Android).

Preferably, the logic may be further configured to initiate and/or accept electronic peer-to-peer payments.

The methods described above may be implemented as a computer program comprising program instructions to operate a computer. The computer program may be stored on a computer-readable medium.

It should be noted that any feature described above may be used with any particular aspect or embodiment of the invention.

### BRIEF DESCRIPTION OF THE FIGURES

The present invention may be put into practice in a number of ways and embodiments will now be described by way of example only and with reference to the accompanying drawings, in which:

FIG. 1 shows a schematic diagram of a system and method for registering a user for financial services using a mobile device;

FIG. 2 shows a schematic diagram of a system for registering the user; and

FIG. 3 shows a flow diagram of the method for registering the user.

It should be noted that the figure is illustrated for simplicity and are not necessarily drawn to scale.

### DETAILED DESCRIPTION OF THE PREFERRED EMBODIMENTS

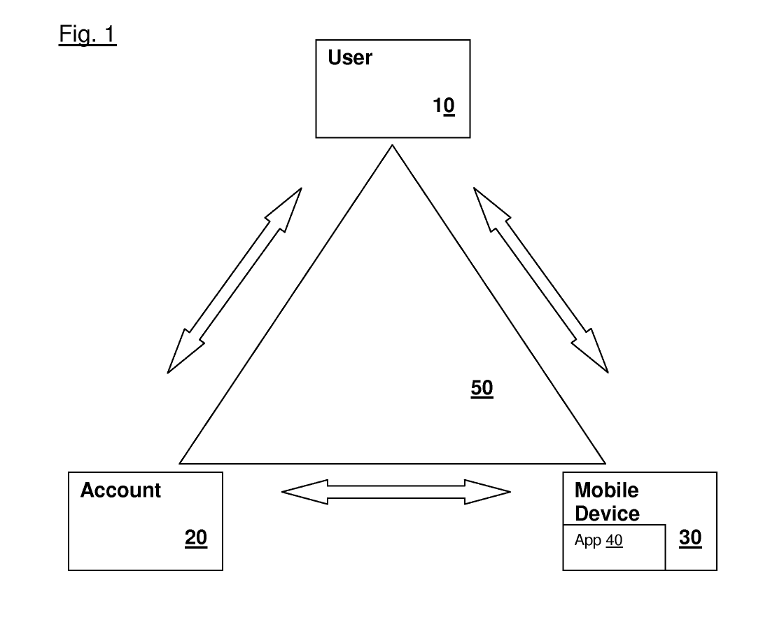

FIG. 1 shows a conceptual diagram of the method for registering a user 10 for an existing financial service such as a bank account 20. The registration process allows the user 10 to access this bank account 20 using their mobile device 30 such as a smart phone, for example.

The registration process is provided through functionality provided by a mobile application 40 operating on the mobile device 30.

In order to ensure that a user is provided access only to their legitimate account 20, then this embodiment creates a “triangle of trust” 50 formed between the user 10, the bank account 20 and the mobile device 30. Conceptually, this triangle of trust 50 is formed by confirming a user 10 is associated with their own bank account 20. The user 10 is then bound to the mobile device 30. This ensures that access to the bank account 20 is correctly provided by the mobile device 30.

Confirming that the user is legitimately associated with a particular bank account 20 may be accomplished in different ways. In one particular implementation, the user 10 provides identification data (for example, their name, date of birth, gender and nationality). The user 10 also provides to the application account data such as an account number and sort code.

Such data are then sent to an external server for validation and confirmation. One way that the account 20 may be validated against a particular user 10 is by sending a small payment to that account (e.g. £0.01) together with a payment reference code. The user may then check their account statement (e.g. from a paper statement, by entering a bank branch, but using an ATM, or by online banking means) and retrieve the payment reference code and enter it into the mobile application 40. Only users 10 with legitimate access to their bank account 20 will be able to easily retrieve such a code and so the user 10 can be validated in this way. Registration of the particular service may be prevented or suspended until successful validation of the account 20.

Whilst this particular validation implementation can be used, it may increase the time necessary to register the user, especially if the small bank payment takes some time to appear on the user's statement.

Alternatively, the user identification data provided to the mobile application 40 may be checked against the account data using an external server, service or database. Such an external service may query a centrally maintained and independent database to determine whether the information provided by the user 10 is accurate and relates to the account data entered. Other validation and verification procedures may be used, especially if the account 20 is directly accessible by the entity holding that account.

Binding the user 10 with the mobile device 30 may similarly be achieved in several ways. In one example implementation, a pass code (such as a password, pass number or pass phrase) may be set by the user 10 when the application 40 is first run and before registration takes place. This allows the mobile application 40 to verify the user. If the registration process is only partially complete, then a pass code challenge will be presented to the user before registration progresses or completes.

The identity of the mobile device may be determined by querying a unique stored number within the device. This unique number may be a MAC address, WiFi identifier, international mobile subscriber identity (IMSI), unique identifier id (UDID), near field communication (NFC) identifier, MSISDN, or IMEI, for example. The unique number may be used to prevent the application and its stored data from being moved to a different mobile device and used to access the bank account 20. This is because each mobile device will have a unique number that is non-transferrable.

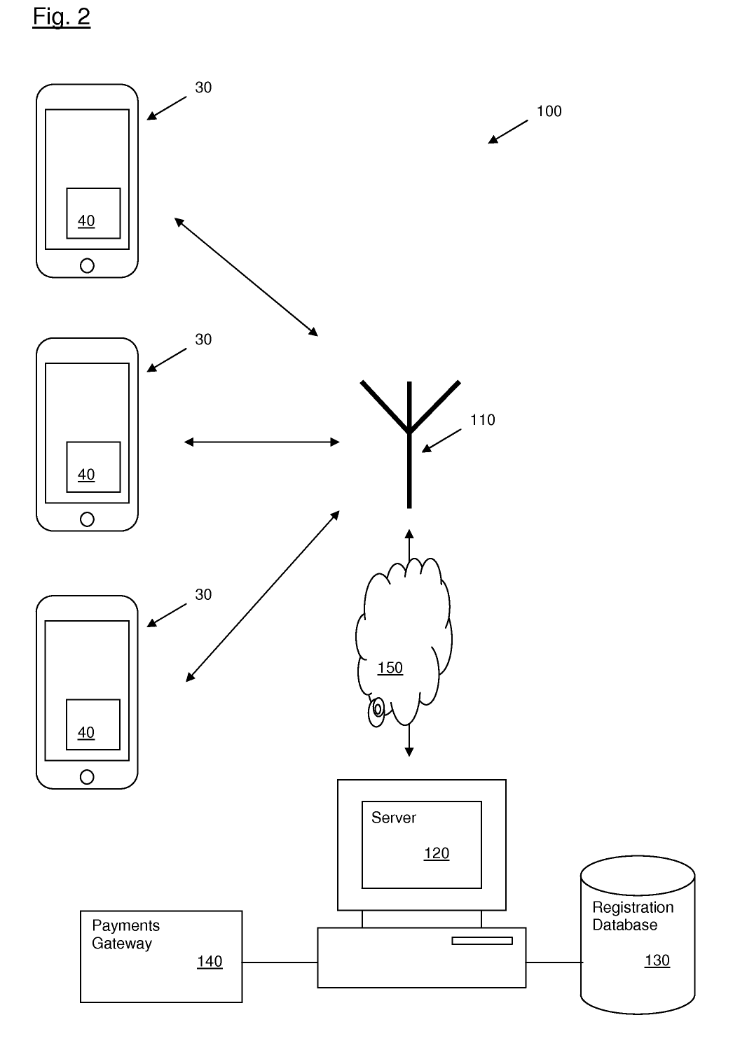

FIG. 2 shows a schematic diagram of a system 100 for registering the user 10. FIG. 2 shows three mobile devices 30 but many more may be used and registered by the system 100. In this example, the mobile devices are smart phones but other mobile devices may be used. The mobile devices 30 communicate wirelessly through a network. In this example, the network is a mobile network 110. The communication medium may also be WiFi, for example.

The mobile network 110 provides a connection to the Internet 150. A server 120 (e.g. a central or core server) is also connected to the Internet 150. Therefore, the mobile devices 30 are provided with a communications channel to the server 120. Preferably, this is a secure communications channel including encryption.

In this example, the users 10 are registered on to a peer-to-peer payment system such a Pingit® operated by Barclays Bank. The server 120 maintains a registration database 130, which stores details of each registered user and their associated account 20 (each user 10 may have more than one account 20 associated or registered with them). The server 120 also provides functionality to process payments to and from users 10 through a payments gateway 140.

During the registration procedure, the server receives user details and account details provided by the user 10. It may also receive data derived from the unique data acquired by the mobile application 40 within each mobile device 30. The server may initiate validation of the account 20 with each user 10, based on these received details and provide success of failure signals based on the outcomes of these validations.

The server 120 may carry out any or all of these processes internally or communicate with external servers (not shown in this diagram) that conduct some or all of the processes.

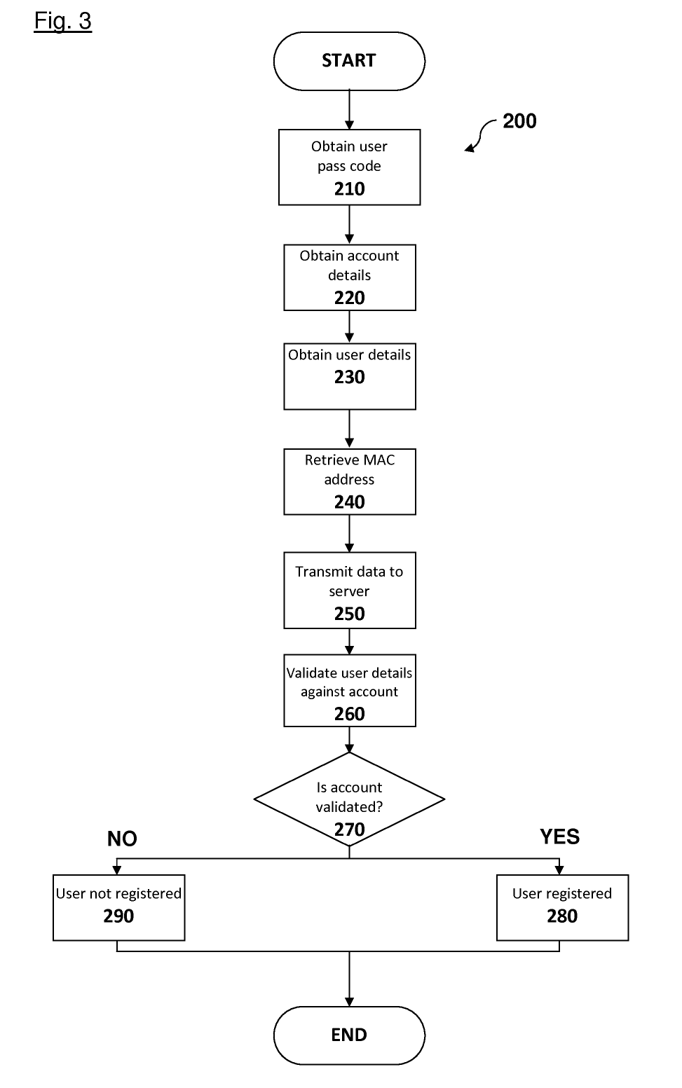

FIG. 3 shows a flow chart describing at a high level the steps carried out in the method 200 for registering a user 10. The mobile application 40 obtains from the user 10 a pass code at step 210. At step 220 the user 10 provides details of their account 20. These details may include account name, number, sort code and bank, for example.

The mobile application 40 retrieves the MAC address of the mobile device 30 at step 240. The MAC address uniquely identifies the mobile device 30 and so may be used to prevent operation of the application on another mobile device for the same account 20. Other mobile device identifiers may be read and used.

The user and account details are transmitted to the server 120 over the mobile network 110 and Internet 150 at step 250. The server may then validate the user 10 against the account 20 using one of a number of procedures or processes, at step 260. Additional data transmission may occur to and from the mobile application 40 during the validation step 260.

A test for validation is carried out at step 270. If the user 10 and account 20 are validated then the user 10 is registered 280 and their details are added to the registration database 130. If validation fails then the user is not registered 290 or marked as unvalidated in the database 130. Registered users may engage in peer-to-peer payments and may obtain other services using the mobile application 40 once successfully registered.

As the user 10 is bound to the mobile device 30 then changing the mobile device 30 (i.e. buying a new mobile phone) will require the user to re-register with the new mobile device 30.

As will be appreciated by the skilled person, details of the above embodiment may be varied without departing from the scope of the present invention, as defined by the appended claims.

For example, communication between the mobile device and the server may be secured by encryption methods to prevent eavesdropping. The procedures operating within the mobile device, including data flows, may also be secured by encryption. Use of the mobile application for a particular service (e.g. peer-to-peer payments) may depend on successful registration and the user may be prevented from using such services without this.

Many combinations, modifications, or alterations to the features of the above embodiments will be readily apparent to the skilled person and are intended to form part of the invention. Any of the features described specifically relating to one embodiment or example may be used in any other embodiment by making the appropriate changes.

1. A method of registering a user of a mobile device comprising the steps of:
obtaining data identifying a user;
obtaining account data;
retrieving data uniquely identifying a mobile device;
authenticating the user with the mobile device; and
validating the user with the account using the data identifying the user and the account data.

2. The method of claim 1, wherein the account is a financial account.

3. The method of claim 1, wherein validating the user occurs outside of the mobile device.

4. The method according to claim 1, wherein the data uniquely identifying the mobile device is any one or more selected from the group consisting of: MAC address, WiFi identifier, international mobile subscriber identity, IMSI, unique identifier ID, UDID, near field communication, NFC, Identifier, MSISDN, and IMEI.

5. The method according to claim 1, wherein authenticating the user with the mobile device comprises a password, pass phrase, pass code or pass number challenge.

6. The method according to claim 1, wherein validating the user comprises the steps of:
sending a payment with a reference to the account;
and receiving from the user the reference.

7. The method according to claim 1, wherein validating the user comprises the steps of:
retrieving user data associated with the account from a third party; and
comparing the retrieved user data with the obtained data identifying the user.

8. The method according to claim 1 further comprising the step of setting an access password, pass phrase, pass code or pass number before obtaining the data identifying the user and obtaining the account data.

9. The method of claim 8 further comprising the step of requiring input from the user of a correct access password, pass phrase, pass code or pass number before the user is registered.

10. The method according to claim 1, wherein the data identifying the user is any one or more selected from the group consisting of: name, date of birth, gender, nationality, place of birth and nationality of parent.

11. The method according to claim 1, wherein obtaining data identifying a user occurs before authenticating the user with the mobile device, which occurs before validating the user the account.

12. The method according to claim 1, wherein the user is registered with a peer-to-peer payments system.

13. A system for registering a user of a mobile device comprising:
a database of registered users; and
logic configured to:
receive data identifying a user,
receive account data,
authenticate the user with the mobile device using data uniquely identifying the mobile device retrieved from the mobile device,
validate the user with the account using the data identifying the user and the account data, and
if the validation is successful, adding the user to the database of registered users.

14. The system of claim 13 further comprising a network connection configured to receive data from one or more mobile devices.

15. The system of claim 13 further comprising an electronic peer-to-peer payment system configured to initiate payments between registered users.

16. A mobile application for registering a user of a mobile device comprising logic configured to:
obtain data identifying a user;
obtain account data;
retrieve data uniquely identifying a mobile device;
authenticate the user with the mobile device; and
receive confirmation that the user and the account have been verified using the data identifying the user and the account data.

17. The mobile application of claim 16, wherein the logic is further configured to initiate and/or accept electronic peer-to-peer payments.

18. (canceled)

19. (canceled)

20. (canceled)

21. A non-transitory computer readable storage medium storing computer readable instructions which, when read by a computer, instruct the computer to perform the method of claim 1.

22. A computer programmed to perform the method of claim 1.
